(19) United States
(12) Patent Application Publication
(10) Pub. No.: US 2005/0069464 A1
(43) Pub. Date: Mar. 31, 2005

(54) Photocatalytic oxidation of contaminants through selective desorption of water utilizing microwaves

(76) Inventors: Timothy N. Obee, South Windsor, CT (US); Stephen O. Hay, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/671,047

(22) Filed: Sep. 25, 2003

(51) Int. Cl. B01J 19/08; B01D 53/26

(52) U.S. Cl. 422/121; 422/186.3

(57) ABSTRACT

A photocatalytic coating oxidizes volatile organic compounds that adsorb onto the coating into water, carbon dioxide, and other substances. When photons of the ultraviolet light are absorbed by the coating, reactive hydroxyl radicals are formed. When a contaminant is adsorbed onto the coating, the hydroxyl radical oxidizes the contaminant to produce water, carbon dioxide, and other substances. Humidity has an effect on the photocatalytic performance of the titanium dioxide coating. Water adsorbs strongly on the coating, and water and contaminants compete for adsorption sites on the coating. A magnetron emits microwaves of the desired wavelength. The microwaves are only absorbed by the adsorbed water, desorbing the water from the photocatalytic coating and creating additional photooxidation sites for the contaminants.

### BACKGROUND OF THE INVENTION

The present invention relates generally to an air purification system that increases the photooxidation rate by reducing the negative effect of humidity on the oxidation process that oxidizes contaminants to carbon dioxide, water and other substances.

Indoor air can include trace amounts of contaminants, including carbon monoxide and volatile organic compounds such as formaldehyde, toluene, propanal, butene, and acetaldehyde. Absorbent air filters, such as activated carbon, have been employed to remove these contaminants from the air. As air flows through the filter, the filter blocks the passage of the contaminants, allowing contaminant free air to flow from the filter. A drawback to employing filters is that they simply block the passage of contaminants and do not destroy them.

Titanium dioxide has been employed as a photocatalyst in an air purifier to destroy contaminants. When the titanium dioxide is illuminated with ultraviolet light, photons are absorbed by the titanium dioxide, promoting an electron from the valence band to the conduction band, thus producing a hole in the valence band and adding an electron in the conduction band. The promoted electron reacts with oxygen, and the hole remaining in the valence band reacts with water, forming reactive hydroxyl radicals. When a contaminant adsorbs onto the titanium dioxide photocatalyst, the hydroxyl radicals attack and oxidize the contaminants to water, carbon dioxide, and other substances.

Water and contaminants compete for adsorption sites on the photocatalyst. As there is a much greater concentration of water than contaminants in the surrounding air, water vapor has a greater probability of occupying a given adsorption site on the photocatalyst. For example, there are thousands of ppmv for water vapor and much less than one ppmv for a gaseous contaminant. Additionally, water forms hydrogen bonds on the photocatalyst that are much stronger than the van der Waals forces that retain a contaminant on the photocatalyst. Water vapor that adsorbs onto the photocatalyst blocks access of the contaminants to the photooxidation sites on the photocatalyst, inhibiting photooxidation of the contaminants.

Photocatalytic activity of the photocatalyst is maximized at about 5 to 30% relative humidity, most preferably at 15% relative humidity. As humidity increases from this range, there is a steep decrease in the photocatalytic rate. For example, at a relative humidity of 60%, the photocatalytic rate decreases by a factor of two. The degree of degradation also depends on the contaminant.

Microwaves can be employed to maintain an optimal photooxidation rate of the contaminants in a humid atmosphere. Microwaves selectively desorb water molecules from the photocatalyst, freeing the photooxidation sites so they can absorb contaminants.

U.S. Pat. No. 5,933,702 discloses a photocatalytic air disinfecting system that operates at a humidity greater than 40%. In this system, photocatalytic performance is increased in increased humidity. However, generally, as humidity increases, the photocatalytic rate decreases because the water competes with the contaminants for adsorption sites on the photocatalyst.

Hence, there is a need in the art for an air purification system that increases the photooxidation rate by reducing the negative effect of humidity on the oxidation process that oxidizes contaminants to carbon dioxide, water and other substances.

### SUMMARY OF THE INVENTION

A fan draws air into an air purification system. The air flows through an open passage or channel of a honeycomb. The surface of the honeycomb is coated with a titanium dioxide photocatalytic coating. An ultraviolet light source positioned between successive honeycombs activates the titanium dioxide coating.

When photons of the ultraviolet light are absorbed by the titanium dioxide coating, an electron is promoted from the valence band to the conduction band, producing a hole in the valence band. The electrons in the conduction band are captured by oxygen. The holes in the valence band react with water that is adsorbed on the titanium dioxide coating, forming reactive hydroxyl radicals. When a contaminant, such as a volatile organic compound, is adsorbed onto the titanium dioxide coating, the hydroxyl radical attacks the contaminant, abstracting a hydrogen atom from the contaminant and oxidizing the volatile organic compounds to water, carbon dioxide, and other substances.

Humidity has an effect on the photocatalytic performance of the titanium dioxide coating. Water adsorbs strongly on the coating, and water and contaminants compete for adsorption sites on the coating.

A magnetron emits microwaves that desorb water adsorbed onto the photocatalytic coating. The frequency of the microwave is selected so that the adsorbed water absorbs the microwaves. By desorbing the water molecules, there is an increase in the number of accessible adsorption sites for the contaminants, increasing the photooxidation rate.

The light source, the honeycomb with the photocatalytic coating, and the magnetron are located between opposing wire screens. A microwave cavity is defined between the opposing wire screens.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates an enclosed environment, such as a building, vehicle or other structure, including an interior space and an HVAC system;

FIG. 2 schematically illustrates the air purification system of the present invention;

FIG. 3 schematically illustrates the honeycomb of the air purification system; and

FIG. 4 schematically illustrates an alternate air purification system.

### DETAILED DESCRIPTION OF THE PREFERRED EMBODIMENT

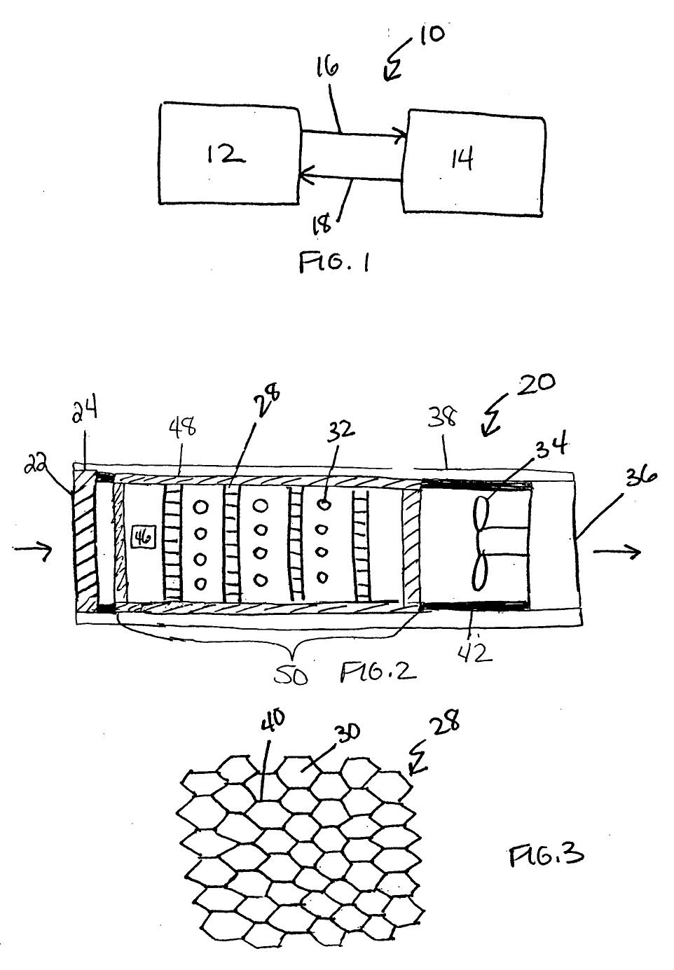

FIG. 1 schematically illustrates a building, vehicle, or other structure 10 including an interior space 12, such as a room, an office or a vehicle cabin, such as a car, train, bus or aircraft. An HVAC system 14 heats or cools the interior space 12. Air in the interior space 12 is drawn by a path 16 into the HVAC system 14. The HVAC system 14 changes the temperature of the air drawn 16 from the interior space 12. If the HVAC system 14 is operating in a cooling mode, the air is cooled. Alternately, if the HVAC system 14 is operating in a heating mode, the air is heated. The air is then returned back by a path 18 to the interior space 12, changing the temperature of the air in the interior space 12. In one example, the air purification system 20 is operated at room temperature.

FIG. 2 schematically illustrates an air purification system 20 employed to purify the air in the building or vehicle 10 by oxidizing contaminants, such as volatile organic compounds and semi-volatile organic compounds, to water, carbon dioxide, and other substances. The volatile organic compounds can be formaldehyde, toluene, propanal, butene, acetaldehyde, aldehydes, ketones, alcohols, aromatics, alkenes, or alkanes. The air purification system 20 can purify air before it is drawn along path 16 into the HVAC system 14 or it can purify air leaving the HVAC system 14 before it is blown along path 18 into the interior space 12 of the building or vehicle 10. The air purification system 20 can also be a stand alone unit that is not employed with a HVAC system 14.

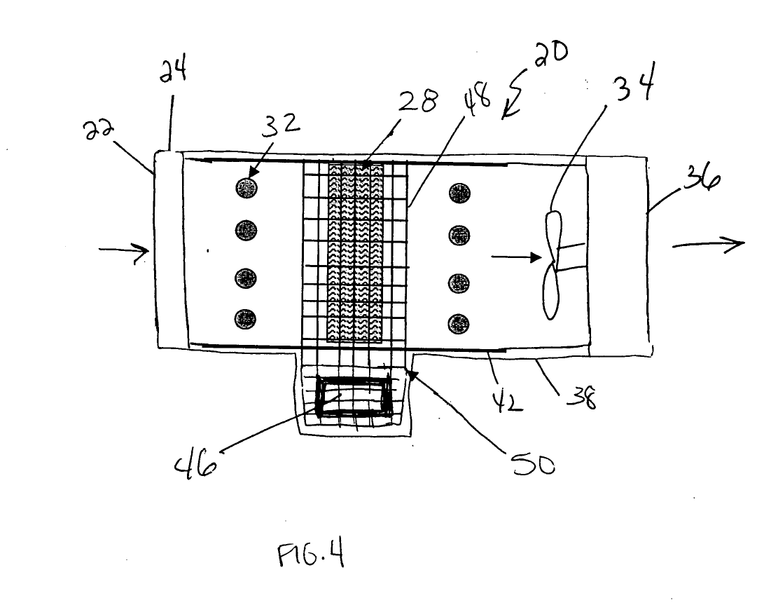

A fan 34 draws air into the air purification system 20 through an inlet 22. The air flows through a particle filter 24 that filters out dust or any other large particles by blocking the flow of these particles. The air then flows through a substrate 28, such as a honeycomb. FIG. 3 schematically illustrates a front view of the honeycomb 28 having a plurality of hexagonal open passages or channels 30. The surfaces of the plurality of open passages 30 are coated with a titanium dioxide photocatalytic coating 40. When activated by ultraviolet light, the coating 40 oxidizes volatile organic compounds that adsorb onto the titanium dioxide coating 40. As explained below, as air flows through the open passages 30 of the honeycomb 28, contaminants that are adsorbed on the surface of the titanium dioxide coating 40 are oxidized into carbon dioxide, water and other substances.

A light source 32 positioned between successive honeycombs 28 activates the titanium dioxide catalytic coating 40 on the surface of the open passages 30. As shown, the honeycombs 28 and the light source 32 alternate in the air purification system 20. That is, there is a light source 32 located between each of the honeycombs 28. Preferably, the light source 32 is an ultraviolet light source which generates light having a wavelength in the range of 180 nanometers to 400 nanometers. However, the light source 32 can also be an ozone generating lamp.

The light source 32 is illuminated to activate the titanium dioxide coating 40 on the surface of the honeycomb 28. When the photons of the ultraviolet light are absorbed by the titanium dioxide coating 40, an electron is promoted from the valence band to the conduction band, producing a hole in the valence band. The titanium dioxide coating 40 must be in the presence of oxygen and water to oxidize the contaminants into carbon dioxide, water, and other substances. The electrons that are promoted to the conduction band are captured by the oxygen. The holes in the valence band react with water molecules adsorbed on the titanium dioxide coating 40 to form reactive hydroxyl radicals.

Titanium dioxide is an effective photocatalyst to oxide volatile organic compounds to carbon dioxide, water and other substances. When a contaminant is adsorbed onto the coating 40, the hydroxyl radical attacks the contaminant, abstracting a hydrogen atom from the contaminant. In this method, the hydroxyl radical oxidizes the contaminants and produces water, carbon dioxide, and other substances.

Preferably, the photocatalyst is titanium dioxide. In one example, the titanium dioxide is Degussa P-25, or an equivalent titanium dioxide. However, it is to be understood that other photocatalytic materials or a combination of titanium dioxide with other metal oxides can be employed, as long as they are active supports for thermocatalytic function. For example, the photocatalytic materials can be Fe₂O₃, ZnO, V₂O₅, SnO₂, or FeTiO₃. Additionally, other metal oxides can be mixed with titanium dioxide, such as Fe₂O₃, ZnO, V₂O₅, SnO₂, CuO, MnOₓ, WO₃, CO₃O₄, CeO₂, ZrO₂, SiO₂, Al₂O₃, Cr₂O₃, or NiO.

The titanium dioxide can also be loaded with a metal oxide to further improve the photocatalytic effectiveness of the coating 40. In one example, the metal oxide is WO₃, ZnO, CdS, SrTiO₃, Fe₂O₃, V₂O₅, SnO₂, FeTiO₃, PbO, CO₃O4, NiO, CeO₂, CuO, SiO₂, Al₂O₃, MnₓO₂, Cr₂O₃, or ZrO₂.

Humidity has an effect on the photocatalytic performance of the titanium dioxide coating 40. Water adsorbs strongly on the hydrophilic coating 40, and water and contaminants compete for adsorption sites on the coating 40. In general, there is more adsorbed water than is needed to generate the hydroxyl radicals. For example, there are thousands of ppmv for water vapor and much less than one ppmv for contaminants. Water also forms hydrogen bonds on the coating 40 that are much stronger than the van der Waals forces that retain a contaminant on the coating 40. Water that adsorbs onto the coating 40 prevents contaminants from adsorbing on the coating 40, reducing the oxidation rate of the contaminants. Therefore, water has a greater probability of occupying a given adsorption site on the coating 40 than a contaminant.

A magnetron 46 emits microwaves that selectively desorb the water adsorbed on the coating 40 and are not adsorbed by the coating 40, the honeycomb 28, the contaminants, or any other material in the air purification system 20. The frequency of the microwave is selected so that the adsorbed water absorbs the microwaves for maximal heating of the adsorbed water. By desorbing the water molecules, there is an increase in the number of accessible adsorption sites for the contaminants, increasing the photooxidation rate. The microwave energy is dissipated among the molecules of adsorbed water, heating the water molecules and desorbing them. Humidity does not affect the coating 40, and the coating 40 can operate at an optimal oxidation rate two or more times greater than the oxidation rate of a system subject to humidity.

The titanium dioxide coating 40, being a crystalline semi-conductor material, does not interact directly with the microwave field. Indirect heating of the coating 40 is possible when absorbed microwave energy is transferred from the adsorbed water to the coating 40. The coating 40 can absorb some microwave energy in this manner, but the amount absorbed is inconsequential.

In IAQ (indoor air quality) applications, the contaminant concentration of individual species in the air in occupied spaces is at most a few tens of ppb. Consequently, the adsorbed contaminant mass will be small, its dielectric loss factor would be corresponding so small or non-existence that absorption of energy from the microwave field will not take place. The absorbed contaminant could only be heated by the microwaves if the contaminant couples, or exchanges energy, with neighboring adsorbed water molecules.

The amount of water adsorbed on the titanium dioxide coating 40 depends on the concentration or partial pressure of water vapor in the air. At low humidity, the adsorbed water molecules do not contact one another and do not effectively dissipate energy from a microwave field. The air purification system 20 of the present invention can also be used at high humidity. At high humidity, the adsorbed water behaves thermodynamically as a two dimensional condensate and heats up when exposed to microwaves. Different wavelengths of microwaves are effective at different levels of humidity, and the optimal microwave intensity changes as the humidity level changes.

A dielectric permittivity is a measure of the polarization of a molecule, and therefore the tendency of the molecule to align itself to an external electric field. Polar molecules reorient their dipoles in response to the changing electric field of an oscillating microwave field. Water is a polar molecule and is likely to absorb microwave energy. Most contaminants are weaker in polarity, do not have a dipole moment and cannot absorb any microwave energy. The dielectric permittivity for contaminants is expected to be much less than the dielectric permittivity water.

Water also has a greater dielectric loss factor (high microwave absorption) compared to titanium dioxide, and is therefore more likely to absorb microwave energy. The wavelength at which the dielectric loss factor for a given temperature is maximized is directly proportional to the cube of the molecular diameter of the molecule. Most contaminants are larger than water molecules, and the maximizing wavelengths for water and most contaminants differ.

The dielectric permittivity and the dielectric loss factor are both temperature and microwave wavelength dependent. As temperature increases, the strength and extent of the hydrogen bonding decrease, lowering the dielectric permittivity and decreasing the difficulty for the movement of the dipole. This allows the water molecule to oscillate at higher frequencies, reducing the drag to the rotation of the water molecules, thus reducing the friction and the dielectric loss factor. For pure water, most of the dielectric loss is within the microwave range of electromagnetic radiation (1-300 GHz). For example, the microwave wavelength for optimal heating of pure water is about 17 GHz at 20° C. and shifts to 38 GHz at 50° C. For adsorbed water on a photocatalyst, the wavelength for maximizing heating of the adsorbed water will also be temperature dependent, although the optimal wavelength may differ from that for pure water. Alternately, radiowaves can be emitted by the magnetron 46 to selectively desorb the water molecules.

The light source 32, the honeycomb 28 with the titanium dioxide coating 40, and the magnetron 46 are located within a microwave cavity 50 defined by wire screens 48 that form a surrounding enclosure. The wire screens 48 prevent microwaves from escaping from the microwave cavity 50. The wire screens 48 also reflect the microwaves within the microwave cavity 50. The openings in the wire screens 48 are smaller than the smallest possible microwaves wavelength to prevent the microwaves from escaping the microwave cavity 50.

Alternately, as shown in FIG. 4, only the honeycomb 28 is located in microwave cavity 50, and the light source 32 is not located in the microwave cavity 50. The wire screens 48 allow the light from the light source 32 to pass and absorb onto the coating 40 on the honeycomb 28. Locating only the honeycomb 28 and the coating 40 in the microwave cavity 50 decouples the light source 32 and the honeycomb 28, preventing the light source 32 from taking microwave energy away from the honeycomb 28.

Reducing the effect of humidity on the coating 40 increases the efficiency of the air purification system 20. Therefore, the air purification system 20 can be made smaller, providing a cost savings.

After passing through the honeycombs 28, the purified air then exits the air purifier through an outlet 36. The walls 38 of the air purification system 20 are preferably lined with a reflective material 42. The reflective material 42 reflects the ultraviolet light onto the surface of the open passages 30 of the honeycomb 28. The microwave cavity 50 defined by the wire screens 48 are located inside the walls 38 of the air purification system 20.

Although a honeycomb 28 has been illustrated and described, it is to be understood that the titanium dioxide coating 40 can be applied on any structure. The voids in a honeycomb 28 are typically hexagonal in shape, but it is to be understood that other void shapes can be employed. As contaminants adsorb onto the titanium dioxide coating 40 of the structure in the presence of a light source, the contaminants are oxidized into water, carbon dioxide and other substances.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. An air purification system comprising:
a substrate; and
a coating applied on said substrate; and
an energy source to desorb water vapor that adsorbs on said coating.

2. The air purification system as recited in claim 1 wherein said energy is microwaves.

3. The air purification system as recited in claim 1 wherein said energy is radiowaves.

4. The air purification system as recited in claim 1 wherein said coating is a photocatalytic coating.

5. The air purification system as recited in claim 4 wherein said photocatalytic coating is titanium dioxide.

6. The air purification system as recited in claim 4 wherein said photocatalytic coating is one of Fe₂O₃, ZnO, V₂O₅, SnO₂, and FeTiO₃.

7. The air purification system as recited in claim 4 wherein said photocatalytic coating includes a metal oxide loaded on a photocatalytic material.

8. The air purification system as recited in claim 7 wherein said metal oxide is one of WO₃, ZnO, CdS, SrTiO₃, Fe₂O₃, V₂O₅, SnO₂, FeTiO₃, PbO, CO₃O4, NiO, CeO₂, CuO, SiO₂, Al₂O₃, MnₓO₂, Cr₂O₃, and ZrO₂.

9. The air purification system as recited in claim 4 further including a light source to activate said photocatalytic coating, and said photocatalytic coating oxidizes contaminants that are adsorbed onto said photocatalytic coating when activated by said light source.

10. The air purification system as recited in claim 9 further including a surrounding enclosure defined by porous screens defining an energy cavity, said substrate, and said photocatalytic coating, and said light source are located in said energy cavity.

11. The air purification system as recited in claim 9 further including a surrounding enclosure defined by porous screens and defining an energy cavity, and said substrate and said photocatalytic coating are located within said surrounding enclosure and said light source is located outside of said surrounding enclosure.

12. The air purification system as recited in claim 9 wherein said light source is an ultraviolet light source.

13. The air purification system as recited in claim 9 wherein said light source is an ozone generating lamp.

14. The air purification system as recited in claim 9 wherein photons from said light source are absorbed by said photocatalytic coating to form a reactive hydroxyl radical that oxidizes contaminants in the presence of oxygen and water to water and carbon dioxide.

15. The air purification system as recited in claim 9 wherein said contaminants are one of a volatile organic compound and a semi-volatile organic compound including at least one of formaldehyde, toluene, propanal, butene, acetaldehyde, aldehyde, ketone, alcohol, aromatic, alkene, and alkane.

16. The air purification system as recited in claim 9 wherein light from said light source does not couple with said desired wavelength of energy.

17. The air purification system as recited in claim 1 wherein said substrate is an array of voids separated by a solid.

18. The air purification system as recited in claim 1 wherein said air purification system operates at room temperature.

19. The air purification system as recited in claim 1 wherein said desired wavelength of energy is absorbed by said water and not absorbed by said coating and said substrate.

20. The air purification system as recited in claim 1 wherein said desired wavelength is selected to desorb said water to maximize heating of said water.

21. The air purification system as cited in claim 1 wherein said desired frequency is 17 GHz at 20° C.

22. The air purification system as cited in claim 1 wherein said desired frequency is 38 GHz at 50° C.

23. The air purification system as recited in claim 1 wherein said energy source generates a desired wavelength of energy to desorb water vapor that adsorbs on said coating.

24. An air purification system comprising:
a substrate; and
an energy source to generate a desired wavelength of energy to desorb water vapor that adsorbs on said substrate.

25. The air purification system as recited in claim 24 wherein said energy is microwaves.

26. The air purification system as recited in claim 24 wherein said substrate is photocatalytic.

27. The air purification system as recited in claim 26 wherein said substrate is titanium dioxide.

28. An air purification system comprising:
a substrate; and
a photocatalytic coating applied on said substrate;
an ozone generating lamp to activate said photocatalytic coating; and
an energy source to generate a desired wavelength of energy to desorb water that adsorbs on said photocatalytic coating.

29. A method of desorbing water comprising the steps of:
selecting a desired wavelength of energy;
emitting said desired wavelength of energy;
absorbing said desired wavelength of energy by said water; and
desorbing said water from a photocatalytic coating including a metal oxide loaded on a photocatalytic material.
